(19) United States
(12) Patent Application Publication
(10) Pub. No.: US 2011/0216859 A1
(43) Pub. Date: Sep. 8, 2011

(54) High-Frequency Signal Receiver Simultaneously Receiving Several Such Signals

(75) Inventor: Alain Bibaut, Igny (FR)

(73) Assignee: Thales, Neuilly-sur-Seine (FR)

(21) Appl. No.: 12/673,801

(22) PCT Filed: Aug. 14, 2008
(86) PCT No.: PCT/EP2008/060698

§ 371 Date: Feb. 17, 2010

(30) Foreign Application Priority Data
Aug. 17, 2007 (FR) 0705885

(51) Int. Cl. H04B 1/10

(52) U.S. Cl. 375/349

(57) ABSTRACT

The present invention relates to a high-frequency signal receiver simultaneously receiving several such signals received by at least one antenna and comprising analog/digital conversion circuits converting these signals into digital form, and this receiver is characterized in that it comprises individual filtering digital circuits respectively filtering each of the carrier frequencies of these signals and digital processing circuits.

The present invention relates to a high-frequency signal receiver simultaneously receiving several such signals, and in particular to an aviation radionavigation receiver.

In order to be located in flight, relative to fixed points on the ground, an aircraft receives a certain number of signals transmitted by beacons situated at these points. These signals make it possible to indicate either the distance to the fixed point, or an orientation in the horizontal plane tangential to the earth and containing this point, or an orientation relative to its local vertical. To process these signals, the aircraft is fitted with a constellation of antennae, connected via coaxial cables to dedicated receivers, the latter being installed in an electronic rack close to the cockpit.

Most of the navigation receivers in question have a similar architecture:
an antenna adapted to the carrier of the signal and to its bandwidth,
a circuit for demodulating the HF (high-frequency) carrier,
a circuit for filtering the demodulated signal so as to keep only the effective frequency band (the video band),
a circuit for sampling the signal obtained at a sampling frequency adapted to the video signal (fₛₐₘ is equal to at least twice the video band in order to comply with the Shannon principle): it is what is called the analog/digital conversion,
a circuit for processing the signal itself,
a supply circuit which converts the power supplied by the aircraft into various direct-current voltages supplying each stage of the receiver,
interfaces for managing the protocols:
   with the bus originating from the central computer of the aircraft;
   with audio outputs for the pilot,
a self-test system (“BITE”: “Built-In Test Equipment”), to ensure the quality of the information supplied.

To carry signals the frequency spectrums of which are adjacent, or even overlapping, the method normally used consists in offsetting these signals in frequency on different carriers before transmitting them.

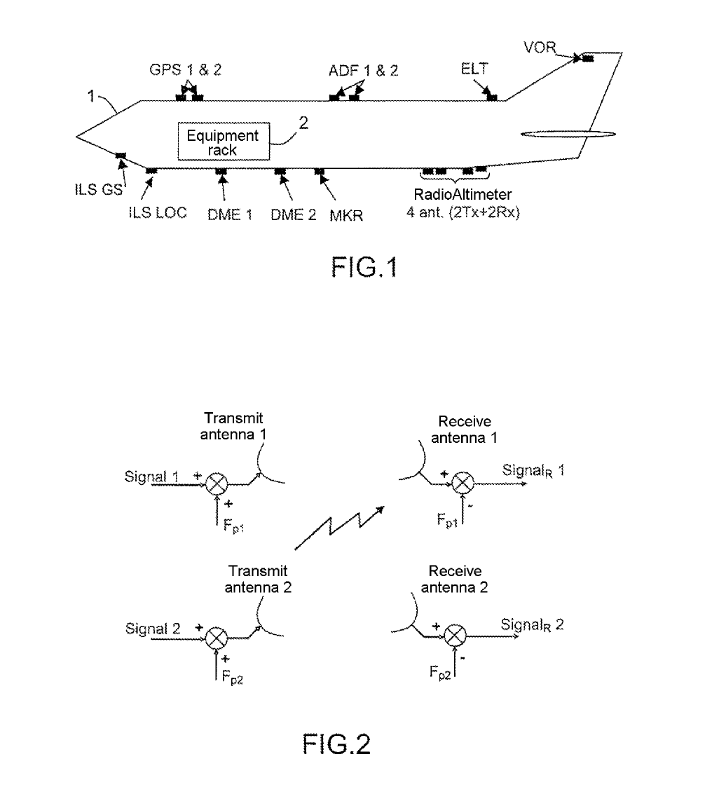

FIG. 1 shows a simplified example of an arrangement of antennae relating to the air navigation equipment of an aircraft 1. These antennae are, in this example, those relating to the following equipment: GPS (two antennae), ADF (“Automatic Direction Finder” with two antennae also), ELT (“Emergency Locator Transmitter”), VOR, ILS-GS (“ILS-Glide Slope”), ILS-LOC (“ILS Localizer”), DME-1 and DME-2 (“Distance Measuring Equipment”), MB (“Marker Beacon”) and radio-altimeter (four antennae in total, namely two for transmission and two for reception). All these antennae are connected via coaxial cables to corresponding transmitting and/or receiving equipment grouped together in an electronic rack 2.

FIG. 2 schematizes a portion of a communication system which may be one of those mentioned above with reference to FIG. 1, for example a GPS system. The signals to be transmitted (before modulation of a carrier wave) in one and the same system are marked “signal 1” and “signal 2”. These signals modulate a carrier wave the frequency of which is respectively marked F_{P1} and F_{P2}. The carrier waves thus modulated are transmitted by transmit antennae which are marked respectively “Transmit antenna 1” and “Transmit antenna 2”. On board an aircraft, reception is provided by the receive antennae “Receive antenna 1” and “Receive antenna 2” respectively, and are demodulated by virtue of the signals of local oscillators having the same frequencies, F_{P1} and F_{P2} respectively. Therefore, after demodulation, the two signals “signal 1” and “signal 2” are retrieved. If necessary, the frequencies of the local oscillators are higher or lower than F_{P1} and F_{P2} respectively by a value IF, which is, in conventional manner, the value of the modulated intermediate frequency that it is desired to obtain at the output of demodulation.

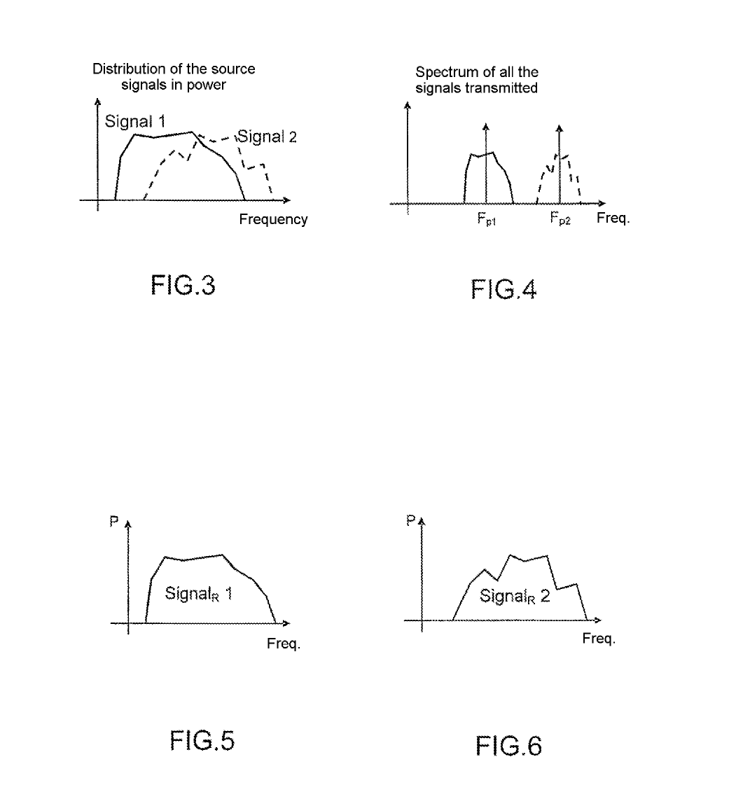

FIG. 3 shows, superposed in one and the same system of coordinates, the diagrams of the signals “signal 1” and “signal 2”, the scales of the frequencies and the powers being common to these two signals. Note a considerable overlap of these two signals.

FIG. 4 shows, in one and the same system of coordinates, the diagrams of the signals transmitted by the aforementioned two antennae. Since their respective carrier frequencies are sufficiently distant from one another, there is no overlap between these two signals.

Finally, FIGS. 5 and 6 respectively show the two signals obtained after demodulation. They are respectively identical (give or take the transmission deformations) to the signals “signal 1” and “signal 2”.

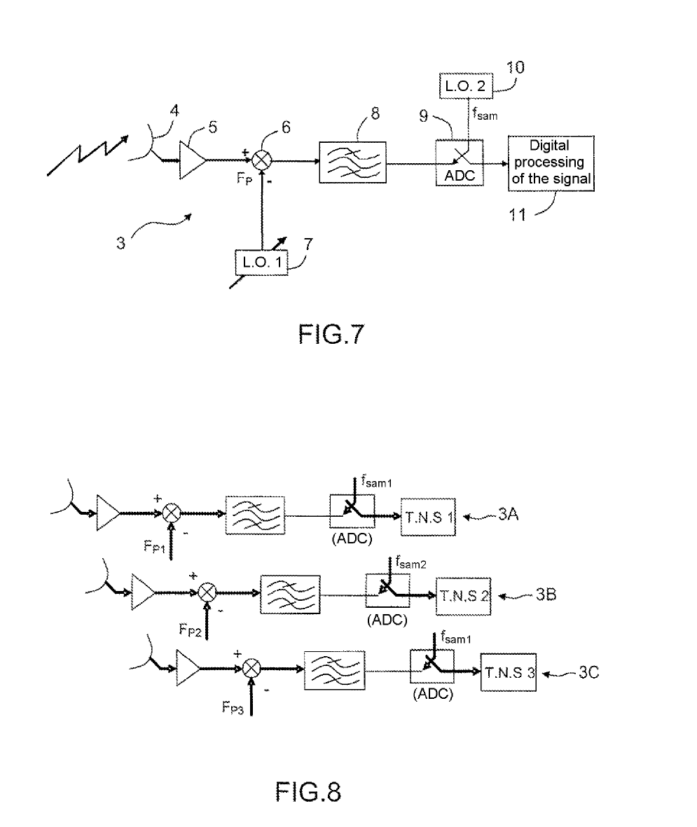

FIG. 7 schematizes a receive channel of a conventional RF signal receiver, for example a receiver of GPS signals. Generally, “RF frequencies” means frequencies, higher than approximately 10 MHz and able to go up to several GHz or tens of GHz. The RF signal originating from a satellite is received by an antenna 4, amplified if necessary by an amplifier 5 and demodulated in a mixer 6 also receiving the signal of a local oscillator 7. The effective signal thus obtained after demodulation enters a filter 8 C responsible for filtering the demodulation harmonic frequencies. The analog signal thus filtered is converted into digital form by a converter 9 the sampling frequency fₛₐₘ is determined by an oscillator 10. The resultant digital signal is sent to an appropriate digital signal processing circuit 11.

When the receiver in question has to receive simultaneously several RF signals with different carriers, use is made of as many receive channels (each comprising the same elements 4 to 11 as the receive channel 3 of FIG. 7) as there are different carrier signals. This has been schematized in FIG. 8 where the three receive channels are referenced 3A, 3B, 3C. In these channels, the frequencies of the demodulation local oscillators are respectively marked F_{P1}, F_{P2} and F_{P3} while the sampling frequencies are respectively marked F_{sam 1}, F_{sam 2} and F_{sam 3}. Naturally, the signal digital processing circuits of these three receive channels are not necessarily identical with one another, but adapted to the processes to be carried out. In avionics, the problem of space, and above all of weight, is very critical and multiplying the number of receive channels is a disadvantage.

Moreover, the components used in the receive channels of known RF receivers must be adapted to the characteristics of the received signals to be processed, which means that, for each function of the receive channel, no generic single component has been proposed hitherto that could be easily adapted to the particular function that it is desired to confer upon it.

The subject of the present invention is an RF signal receiver that can simultaneously receive several RF signals while comprising fewer circuits than the known RF receivers and having performance at least as good as these known receivers.

A further subject of the present invention is a generic module that can be used in the possible large number of these receivers, by programming it specifically for each task.

A further subject of the present invention are such generic modules that can process several signals simultaneously when their characteristics allow.

The receiver according to the invention is a high-frequency signal receiver receiving simultaneously several such signals received by at least one antenna and comprising analog/digital conversion circuits converting these signals into digital form, and it is characterized in that it comprises individual filtering digital circuits respectively filtering each of the carrier frequencies of these signals and digital processing circuits. Advantageously, the filtering digital circuits are band-pass filters.

According to another feature of the invention, the receiver comprises, for signals the carrier of which is higher than the maximum available sampling frequency, a demodulation circuit upstream of the analog/digital conversion circuit and a circuit for filtering the demodulation harmonics, and the individual filtering digital circuits are carrier residue filters.

The present invention will be better understood on reading the detailed description of one embodiment, taken as a nonlimiting example and illustrated by the appended drawing, in which:

FIG. 1, already described above, is a very simplified diagram showing an example of the location of antennae of a conventional civil aircraft,

FIG. 2, already described above, is a simplified diagram showing how, according to the prior art, two signals with adjacent frequency spectrums are transmitted and received,

FIGS. 3 to 6, already described above, are amplitude/frequency diagrams of the signals appearing in the system of FIG. 2,

FIG. 7, already described above, is a block diagram of a conventional RF signal receiver,

FIG. 8, already described above, is a block diagram of a conventional receiver similar to that of FIG. 7, but modified for the purpose of simultaneously receiving several RF signals with different carrier frequencies,

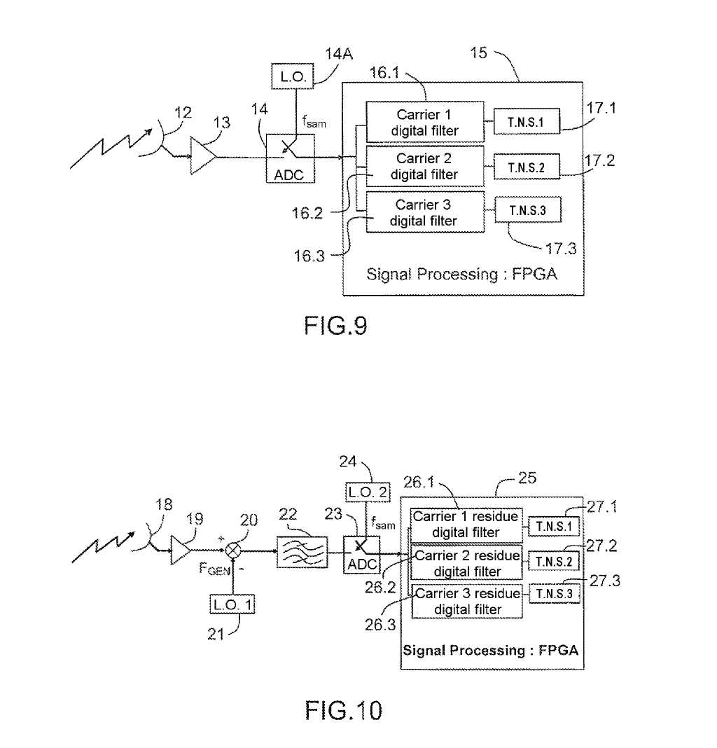

FIGS. 9 and 10 are block diagrams of RF signal receivers according to the present invention,

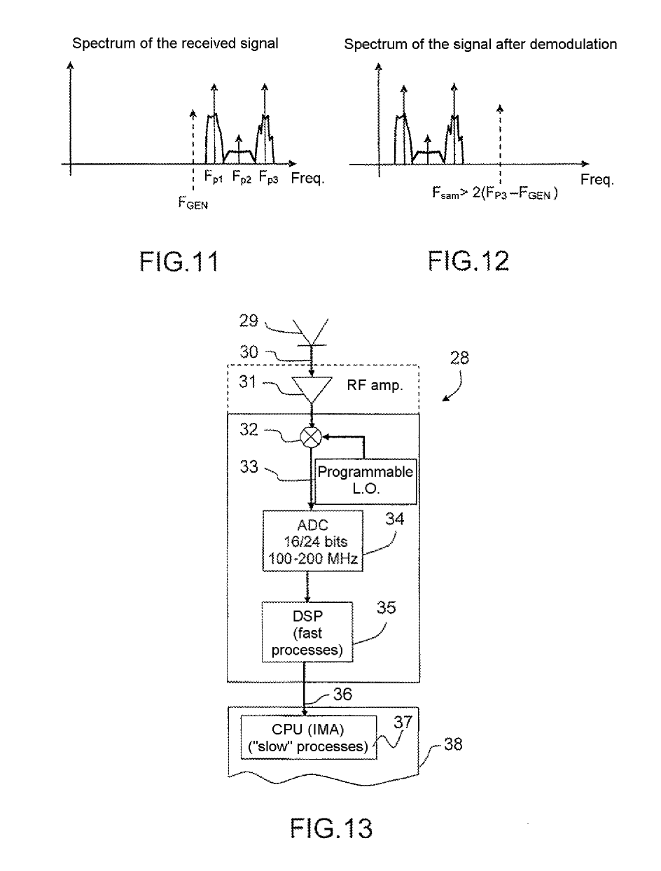

FIGS. 11 and 12 are amplitude/frequency diagrams of the signals as received by the receiver of the invention and after demodulation by this receiver, and

FIG. 13 is a block diagram of an exemplary embodiment of a generic module according to the present invention.

The present invention is described below with reference to the production of receivers on board aircraft, but it is well understood that it is not limited to this sole application, and that it may be applied in any system capable of simultaneously receiving several high-frequency signals, and in particular carrier frequency signals higher than 100 MHz, the carrier frequencies of which are close to one another.

The technological progress made in the last twenty years in the field of sampling and in that of the processors used for the digital processing of the signal make it possible today to capture the signals, with sampling frequencies that are very high, even above the carrier frequencies used.

The present invention proposes to achieve the demodulation of the afore-mentioned RF signals directly in digital form.

An important feature of the invention is therefore to simultaneously process several radiofrequency signals, directly in digital, by filtering the carrier frequencies through adapted digital filters. The object of these filters is to eliminate the demodulation residues (frequency differences relative to the carrier due mainly to the movements of the aircraft) and also to process elaborate waveforms such as: BPSK, D8-PSK (specific to the VDB signal delivered by the ILS beacons), etc.

FIG. 9 schematizes a receive channel according to the invention. This channel comprises, in the order of transfer of the signals received by a wide band antenna 12: an amplification stage 13, an analog/digital converter 14 the sampling frequency of which is determined by a local oscillator 14A, and a digital signal processing module 15. The received signals are, in the present example, three in number (but it is well understood that this number may be different) and have respectively for a carrier frequency Fₚ₁, Fₚ₂ and Fₚ₃. It is assumed here that the three carrier frequencies are sufficiently close to one another to be framed by the output band of the mixer. The module 15 comprises, in the example shown, for the three signals to be processed, three processing channels in parallel each comprising a digital filter of the band-pass type, respectively referenced 16.3 to 16.3, each followed by a signal-processing digital circuit, respectively referenced 17.1 to 17.3. The filters 17.1 to 17.3 are band-pass filters the central frequency of which is respectively equal to the carrier frequency of each of the aforementioned three signals.

The local oscillator 14 delivers a sampling frequency Fₛₐₘ the value of which, in the present example, is greater than the largest of the three carrier frequencies. If the maximum possible sampling frequency is lower than the smallest of the three carrier frequencies (Fₚ₁, Fₚ₂ and Fₚ₃), the receive channel shown in FIG. 10 is used.

The receive channel of FIG. 10 comprises, in the order of transfer of the signals received by a wide band antenna 18: an amplification stage 19, a mixer 20 connected to a first local oscillator 21 (supplying a signal oscillating at the frequency F_{GEN}), a demodulation harmonics filtering circuit 22, an analog/digital converter 23 connected to a second local oscillator 24 (supplying a signal oscillating at the frequency Fₛₐₘ) and a digital processing module 25. This module 25 comprises, for each of the three signals received and converted, a carrier residue digital filter (26.1 to 26.3 respectively) followed by an appropriate digital processing circuit (27.1 to 27.3 respectively).

The diagram of FIG. 11 shows the spectrum of the three signals received by the receive channel of FIG. 10. These signals have carrier frequencies such that Fₚ₁<Fₚ₂<Fₚ₃ and that these signals do not overlap one another, while being as close as possible to one another (so that the antenna 18 can transmit them all practically without weakening them). The frequency of the signal of the oscillator 24 is lower than Fₚ₁.

The diagram of FIG. 12 shows the spectrum of the three signals after demodulation, just before filtering by the filter 22. In order to satisfy the Shannon criterion, the sampling frequency Fₛₐₘ is chosen such that:

Fₛₐₘ>2(Fₚ₃−F_{GEN})

These spectrums of FIG. 12 are the same as those of FIG. 11, but all of the three spectrums are offset toward lower frequencies, lower than Fₛₐₘ.

The value of these architectures of FIGS. 9 and 10 is to use only one RF channel, common to all the signals that it is sought to process. This makes it possible to considerably reduce the quantity of RF components (usually costing more than MF hardware or digital hardware) and to transfer the specifics of MF processing into the digital portion.

Similarly, the “signal processing” portion also has a large number of common points from one receiver to another with respect to the management of the interfaces (buses, audio outputs) and to the management of the self-tests.

FIG. 13 shows a simplified diagram of a practical exemplary embodiment of a generic module according to the invention, that can be customized in order to form it into a receive channel of an aviation receiver. This receive channel may comprise some or all of the elements 13 to 15 of FIG. 9 or else, with a few adaptations, some or all of the elements 19 to 25 of FIG. 10.

The generic module 28 is connected to an antenna 29 via a coaxial cable 30 followed by an RF amplifier 31. As a variant, the amplifier 31 may be incorporated into the module 28, as shown in dashed lines in the figure. According to another variant (not shown), it is possible to insert between the antenna 29 and the amplifier 31 a battery of several filters placed in parallel, one of these filters or several of them being effectively connected, as required, between the antenna and the amplifier by means of appropriate switches.

The module 28 comprises, in this example, a mixer 32 connected on the one hand to the output of the amplifier 31 and on the other hand to a programmable oscillator 33. The output of the mixer 32 is connected to a programmable analog/digital converter 34. The output of the converter 34 is connected to a programmable digital processing block 35 carrying out processes similar to those carried out by the module 15 of FIG. 9, that is to say rapid signal processes on all the N received signals (and therefore comprising N digital filters and N digital processing circuits, not shown in the drawing). Advantageously, the module 28 is placed immediately next to the antenna 29 and is connected via a digital bus 36 to the central computer 37 of the aircraft, placed in the electronic rack 38 (similar to the rack 2 of FIG. 1, but, according to another feature of the invention, comprising no or practically no centralized receivers). The elements 33, 34 and 35 are advantageously produced as logic circuits of the ASIC or FPGA type. These circuits, and in particular the digital processing circuit 35 may therefore carry out rapid processes, while the computer 37 carries out “slow” processes. The module 28 can be easily placed in a small-dimension case (for example with a volume of approximately 1 liter), and it can be supplied by a single direct-current supply voltage suited to all the circuits that it contains.

One worthwhile application of the module of the invention may be the simultaneous processing of the ILS Loc and of the VOR which work at adjacent carrier VHF frequencies.

Another application, in the L band, could be the simultaneous reception of GPS, SatCom and DME. However, the two receivers, DME and SatCom, work both in transmit and in receive mode, which is usually an obstacle for the integration of these three functions in one and the same module.

The concept of generic navigation module is reversible, that is to say that it is possible to prepare the signals to be transmitted in the DSP, and then modulate them (after digital/analog conversion) on a carrier adapted to the subband to be transmitted. However, the invention, in this case, can be applied only to signals having common encoding dynamics (adjacent energy levels) in order to have a common technology. This is not the case with SatCom (60 Wₘₐₓ) and DME (20 W_{medium}, 300 Wₚₑₐₖ).

This method therefore, in the first analysis, applies more advantageously to passive receivers such as:
ILS Loc
ILS G/S
VOR
MKR
ADF

According to the invention, the architecture that has the best user-friendliness/cost ratio for systems of radionavigation and measurement of magnitudes outside the aircraft, whether it be in terms of development, production or installation cost, is often that which consists in installing one generic receiver module per antenna, which single receiver will be programmed at the time of installation, this receiver being placed as close as possible to the antenna, connected via a digital bus to the central computer (usually that of the rack similar to the rack 2 of FIG. 1, but comprising no or practically no centralized receivers) and supplied by a centralized supply of the rack.

1. A high-frequency signal receiver receiving simultaneously several such signals received by at least one antenna and comprising analog/digital conversion circuits converting these signals into digital form, further comprising individual filtering digital circuits respectively filtering each of the carrier frequencies of these signals and digital processing circuits, and further comprising, for signals the carrier of which is higher than the maximum available sampling frequency, a demodulation circuit upstream of the analog/digital conversion circuit and a circuit for filtering the demodulation harmonics, and that the individual filtering digital circuits are carrier residue filters.

2. The receiver as claimed in claim 1, wherein the filtering digital circuits are band-pass filters.

3. (canceled)

4. The receiver as claimed claim 1, wherein at least a portion of its digital components is included in an integrated-circuit module.

5. The receiver as claimed in claim 4, wherein at least a portion of the digital components of the module is programmable.

6. The receiver as claimed in claim 4, wherein the module also comprises an RF amplifier.

7. The receiver as claimed in claim 6, wherein the module also comprises a battery of switchable filters downstream of the antenna.

8. (canceled)
